(19) United States
(12) Patent Application Publication
(10) Pub. No.: US 2006/0278607 A1
(43) Pub. Date: Dec. 14, 2006

(54) Method for fabricating semiconductor device with step gated asymmetric recess structure

(75) Inventor: Ki-Won Nam, Ichon-shi (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: HYNIX SEMICONDUCTOR, INC.

(21) Appl. No.: 11/296,528

(22) Filed: Dec. 8, 2005

(30) Foreign Application Priority Data
Jun. 10, 2005 (KR) 2005-0049983

(51) Int. Cl. C23F 1/00; B44C 1/22; C03C 15/00

(52) U.S. Cl. 216/41; 216/83; 216/99

(57) ABSTRACT

A method for fabricating a semiconductor device with a step gated asymmetric recess structure is provided. The method includes: forming an anti-scattering reflection layer on a substrate; forming a mask on the anti-scattering reflection layer; etching the anti-scattering reflection layer using the mask as an etch barrier; and etching predetermined portions of the substrate using the mask as an etch barrier to thereby form recessed active regions and a protruded active region.

### FIELD OF THE INVENTION

The present invention relates to a method for fabricating a semiconductor device; and, more particularly, to a method for fabricating a semiconductor device with a step gated asymmetric recess (STAR) structure.

### DESCRIPTION OF RELATED ARTS

Recently, when sub-100 nm level dynamic random access memory (DRAM) devices are fabricated, a refresh characteristic is often deteriorated due to a short channel effect. To overcome such a limitation, a step gated asymmetric recess (STAR) technology is introduced. The STAR technology includes a recessed portion of an active region in a depth of several tens of nanometers, and having a portion of a gate extending over the recess.

FIG. 1 is a cross-sectional view briefly illustrating a conventional method for fabricating a semiconductor device by employing the STAR technology.

As shown in FIG. 1, device isolation regions 12 with a trench structure are formed in a substrate 11 using a shallow trench isolation (STI) process.

Subsequently, a bottom anti-reflective coating (BARC) layer 13 is formed on the substrate 11, and a photoresist layer (not shown) is formed on the BARC layer 13. The photoresist layer is patterned by a photo-exposure and developing process to form a STAR mask 14.

Furthermore, the BARC layer 13 is etched using the STAR mask 14 as an etch barrier, and then, the substrate 11 is etched in a predetermined depth ‘D’ to form a STAR pattern 15.

The above described conventional method introduces the BARC layer 13 to perform the patterning process of the STAR mask 14 with ease. The BARC layer 13 has satisfactory fluidity regardless of the size of the pattern, and shows a fine difference in thickness for each pattern with a difference size.

FIG. 2 is a cross-sectional view illustrating a difference in thickness between a BARC layer of a main cell and that of a test pattern when the above conventional method is employed. Particularly, FIG. 2 is a cross-sectional view of the main cell and the test pattern for measuring the depth of a STAR pattern. Because the depth of the STAR pattern cannot be measured in the finely formed main cell, the test pattern is instead formed on an adjacent device isolation pattern in a peripheral region to monitor the depth of the STAR pattern.

As shown in FIG. 2, a first thickness difference, i.e., D2<D1, between the BARC layers 13 is generated due to the difference in a spacing distance between the patterns with respect to a measurement point between the main cell and the test pattern.

FIG. 3 shows cross-sectional views illustrating an effective field oxide height (EFH) difference between an active region and a device isolation region in a conventional main cell. FIG. 3 shows a difference in depth between BARC layers 13 caused by the EFH difference.

As shown in FIG. 3, the thickness variations D3 and D4 occur in the BARC layers 13 according to the EFH differences EFH1 and EFH2 between the active region and the device isolation region, and so a difference in thickness between the BARC layers 13 increases regionally on the wafer.

Currently, the depth of the STAR pattern is targeted at approximately 400 Å. As shown in FIGS. 2 and 3, when the difference in thickness between the BARC layers 13 is generated, regional variations of etch targets of the STAR pattern are made on the wafer, resulting in regionally different silicon etch losses. Thus, variations in refresh, resistance, and cell threshold voltage are increased within the wafer. That is, the STAR pattern in a uniform depth may not be secured due to the EFH difference between the active region and the device isolation region, as well as the difference in spacing distance with respect to the measurement point between the main cell and the test pattern.

### SUMMARY OF THE INVENTION

It is, therefore, an object of the present invention to provide a method for fabricating a semiconductor device capable of securing a uniform thickness in a STAR pattern.

In accordance with an aspect of the present invention, there is provided a method for fabricating a semiconductor device, including: forming an anti-scattering reflection layer on a substrate; forming a mask on the anti-scattering reflection layer; etching the anti-scattering reflection layer using the mask as an etch barrier; and etching predetermined portions of the substrate using the mask as an etch barrier to thereby form recessed active regions and a protruded active region.

### BRIEF DESCRIPTION OF THE DRAWINGS

The above and other objects and features of the present invention will become better understood with respect to the following description of the specific embodiments given in conjunction with the accompanying drawings, in which:

FIG. 1 is a cross-sectional view illustrating a conventional method for fabricating a semiconductor device using a STAR technology;

FIG. 2 is a cross-sectional view illustrating a difference in thickness between a BARC layer of a main cell and that of a test pattern in accordance with the conventional method for fabricating a semiconductor device;

FIG. 3 shows cross-sectional views illustrating an effective field oxide height (EFH) difference between an active region and a device isolation region in a conventional main cell; and

FIGS. 4A to 4E are cross-sectional views illustrating a method for fabricating a semiconductor device in accordance with a specific embodiment of the present invention.

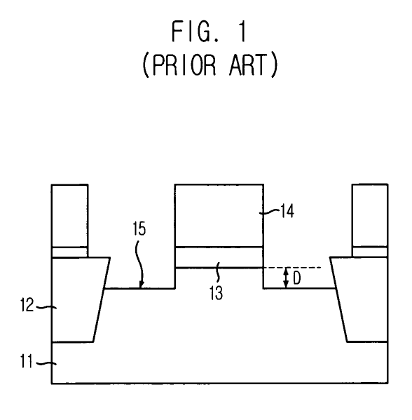

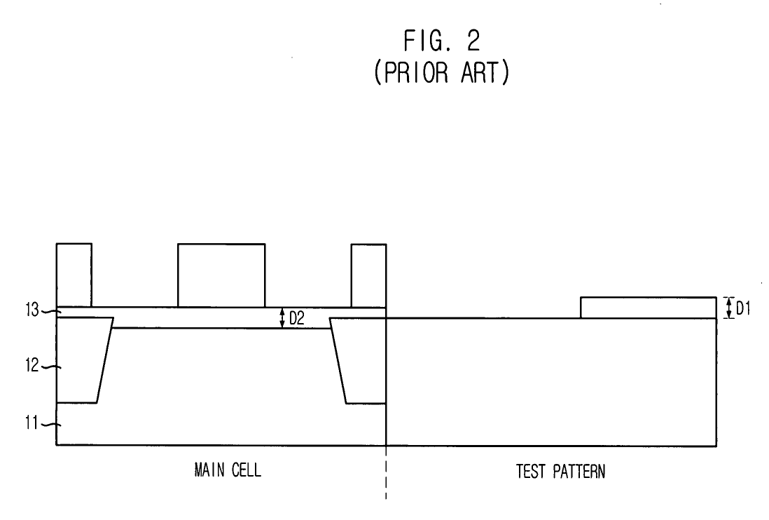

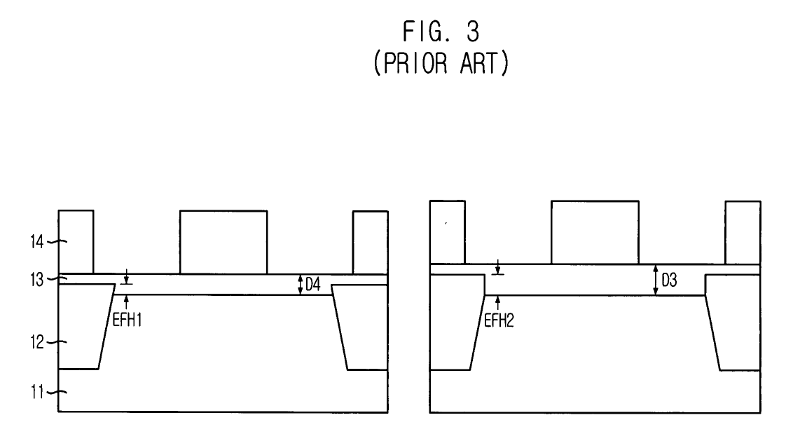

### DETAILED DESCRIPTION OF THE INVENTION

A method for fabricating a semiconductor device with a step gated asymmetric recess structure in accordance with specific embodiments of the present invention will be described in detail with reference to the accompanying drawings.

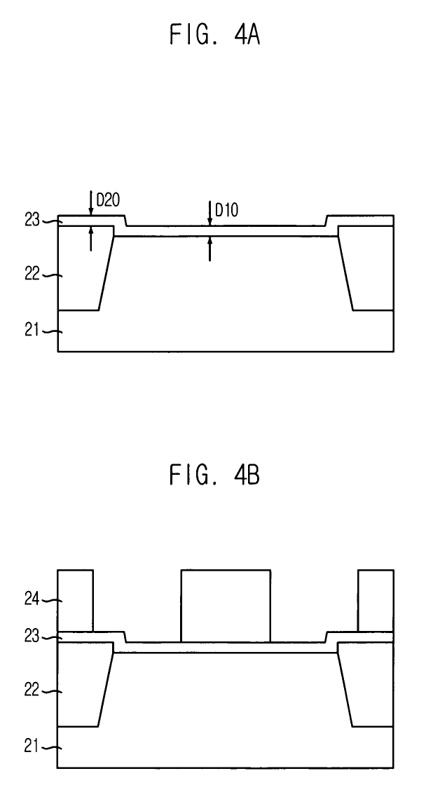

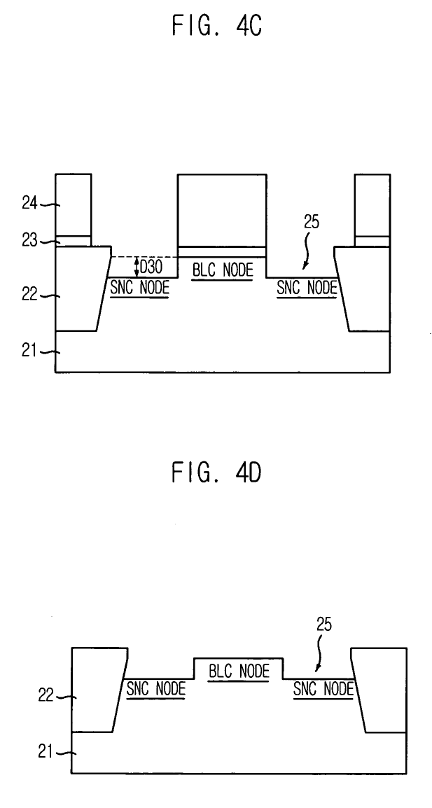

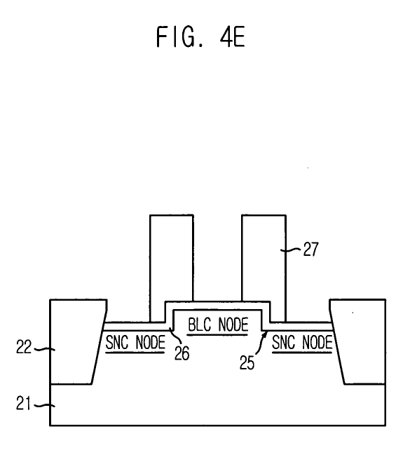

FIGS. 4A to 4E are cross-sectional views illustrating a method for fabricating a semiconductor device in accordance with a specific embodiment of the present invention.

As shown in FIG. 4A, device isolation regions 22 with a trench structure are formed in a substrate 21 using a shallow trench isolation (STI) process.

Subsequently, an anti-scattering reflection layer 23, which inhibits scattering reflection, is formed on the substrate 21 for a photo mask process. Herein, the anti-scattering reflection layer 23 is formed by employing a nitride-based layer. The anti-scattering reflection layer 23 and a bottom anti-reflective coating (BARC) layer function identically. That is, the anti-scattering reflection layer 23 inhibits scattering reflection during a photo mask process, resulting in an easier patterning process of a step gated asymmetric recess (STAR) mask.

A refractive index of the anti-scattering reflection layer 23 should be ranging at approximately 1.9±0.04 to perform the patterning process of the STAR mask with ease. Therefore, the anti-scattering reflection layer 23 is formed by employing a silicon oxynitride (SiON)-based nitride layer, instead of a silicon nitride (Si₃N₄)-based pure nitride layer. Herein, the SiON-based nitride layer is obtained by employing a mixed gas of silane (SiH₄)/nitrous oxide (N₂O) with helium (He) as an inert gas. Thus, scattering reflection during a follow-up STAR mask process is inhibited to the minimum, resulting in a normal mask patterning process. The anti-scattering reflection layer 23 is formed in a thickness ranging from approximately 100 Å to approximately 900 Å.

Furthermore, the anti-scattering reflection layer 23 has a superior step coverage characteristic unlike the BARC layer, and thus the anti-scattering reflection layer 23 can be formed on a layer in a uniform thickness regardless of the bottom surface topology. That is, the thickness ‘D10’ of the anti-scattering reflection layer 23 formed on the substrate 21 and the thickness ‘D20’ of the anti-scattering reflection layer 23 formed on the device isolation region are identical.

As shown in FIG. 4B, a photoresist layer is formed on the anti-scattering reflection layer 23, and is patterned by a photo-exposure and developing process to form a STAR mask 24.

The patterning process of the STAR mask 24 can be performed with ease because the anti-scattering reflection layer 23 is formed at the bottom with a refractive index controlled at approximately 1.9±0.04.

As shown in FIG. 4C, the anti-scattering reflective layer 23 is etched using the STAR mask 24 as an etch barrier, and the substrate 21 is etched in a predetermined depth ‘D30’ to form STAR patterns 25. The above described process is referred to as the ‘STAR etch process’, and the STAR patterns 25 are formed with a recess structure. Portions where the STAR patterns 25 are formed are ‘SNC nodes’, on which storage node contacts are to be connected to, and a portion below the STAR mask 24 is a ‘BLC node’, on which a bit line contact is to be connected to.

As described above, the BLC node and the SNC nodes with a difference in height are formed by employing the STAR etch process. That is, the BLC node is formed to protrude above the SNC nodes. Hereinafter, the BLC node is referred to as the protruded active region, and the SNC nodes are referred to as the recessed active regions.

During the STAR etch process, the anti-scattering reflection layer 23, formed by employing the SiₓO_{y}N_{z}-based nitride layer, is etched by a fluorine-based gas. The BARC layer can also be etched by a fluorine-based gas. That is, because the specific embodiment of the present invention is carried out under conventional BARC etch conditions, additional processes and condition controls are minimized.

On the other hand, the etching process of the substrate 21 for forming the STAR patterns 25 is performed by employing a mixed gas of hydrogen bromide (HBr), chlorine (Cl₂), and oxygen (O₂).

As shown in FIG. 4D, the STAR mask 24 is stripped, and a cleaning process is performed. Herein, the anti-scattering reflection layer 23 still remains after the STAR mask 24 is stripped.

The anti-scattering reflective layer 23 is removed by an additional wet etching process. Herein, the wet etching process utilizes a wet chemical, e.g., phosphoric acid (H₃PO₄).

During the wet etching process of the anti-scattering reflective layer 23, lattice defects may occur on surfaces of the STAR patterns 25, generated by the wet chemical. Thus, a high temperature heat treatment is performed to heal the lattice defect. The high temperature heat treatment is performed at a temperature ranging from approximately 700° C. to approximately 1,000° C.

Referring to FIG. 4E, a screen oxide layer (not shown) is formed on the above resulting substrate structure to protect the substrate 21 during ion implantation processes. Herein, the ion implantation processes are performed to control a gate critical voltage, that is, a threshold voltage. Subsequently, the ion implantation processes for forming wells and channels are sequentially performed, and a gate oxide layer 26 is formed. Then, a gate structure, although not illustrated, is formed. Herein, the gate structure includes a doped polysilicon layer, a tungsten silicide layer, and a gate hard mask layer, formed in sequential order. Next, step gated asymmetric recess structures 27 are formed by performing a gate mask and an etching processes. Herein, the step gated asymmetric recess structures 27 extend over portions of the protruded active region (BLC node) and the recessed active regions (SNC nodes).

In accordance with the specific embodiment of the present invention, by introducing the nitride-based anti-scattering reflection layer 23 with a superior step coverage, a difference in depth of the STAR patterns 25 caused by: an effective field oxide height (EFH) difference between the active region and the device isolation region; and a difference in spacing distance with respect to a measurement point between a main cell and a test pattern, is moderated.

Furthermore, by ranging the refractive index of the anti-scattering reflection layer 23 at approximately 1.9±0.04, scattering reflection during the follow-up photo mask process of the STAR mask is inhibited to the minimum, resulting in a normal mask patterning.

Moreover, there occurs no additional investment cost because the etching process and conditions identical to the conventional BARC layer etching process is utilized.

In accordance with the specific embodiment of the present invention, by introducing the nitride-based anti-scattering reflection layer for the STAR mask patterning, the STAR patterns are formed in a uniform thickness over the entire surface of the wafer, resulting in minimized variations of electrical characteristics, i.e., refresh, resistance, and cell threshold voltage.

The present application contains subject matter related to the Korean patent application No. KR 2005-0049983, filed in the Korean Patent Office on Jun. 10, 2005, the entire contents of which being incorporated herein by reference.

While the present invention has been described with respect to certain specific embodiments, it will be apparent to those skilled in the art that various changes and modifications may be made without departing from the spirit and scope of the invention as defined in the following claims.

What is claimed is:

1. A method for fabricating a semiconductor device, comprising:
forming an anti-scattering reflection layer on a substrate;
forming a mask on the anti-scattering reflection layer;
etching the anti-scattering reflection layer using the mask as an etch barrier; and
etching predetermined portions of the substrate using the mask as an etch barrier to thereby form recessed active regions and a protruded active region.

2. The method of claim 1, wherein the anti-scattering reflection layer is formed by employing a nitride-based layer with a refractive index ranging at approximately 1.9±0.04.

3. The method of claim 2, wherein the nitride-based layer includes a silicon oxynitride (SiON)-based nitride layer.

4. The method of claim 3, wherein the SiON-based nitride layer is obtained by employing a mixed gas of silane (SiH₄)/nitrous oxide (N₂O) with helium (He) as an inert gas.

5. The method of claim 3, wherein the nitride-based layer is formed in a thickness ranging from approximately 100 Å to approximately 900 Å.

6. The method of claim 1, wherein the removing of the anti-scattering reflection layer utilizes a phosphoric acid solution.

7. The method of claim 5, after the removing of the anti-scattering reflection layer, further including performing a heat treatment for healing lattice defects generated on surfaces of the recessed active regions and the protruded active region.

8. The method of claim 6, wherein the heat treatment is performed at a temperature ranging from approximately 700° C. to approximately 1,000° C.
